(19) United States
(12) Patent Application Publication
(10) Pub. No.: US 2025/0355262 A1
(43) Pub. Date: Nov. 20, 2025

(54) Mechanical Alignment via a Flexure

(71) Applicant: Avegant Corp., San Mateo, CA (US)

(72) Inventors: Anthony Blaine Bailey, JR., Millbrae, CA (US); Christopher David Westra, San Carlos, CA (US); Edward Chia Ning Tang, Menlo Park, CA (US); Michael Alexander Young, Belmont, CA (US); Amy Sasha Ishiguro, Hayward, CA (US)

(73) Assignee: Avegant Corp., San Mateo, CA (US)

(21) Appl. No.: 19/208,515

(22) Filed: May 14, 2025

Related U.S. Application Data
(60) Provisional application No. 63/648,079, filed on May 15, 2024.

(51) Int. Cl. G02B 27/01

(52) U.S. Cl. CPC G02B 27/0176; G02B 27/0172; G02B 2027/0154; G02B 2027/0178

(57) ABSTRACT

A light engine alignment system for a head-mounted device comprises a light engine, a flexure coupled to the light engine, the flexure used to position the light engine at a particular alignment to set a projection axis, and a fastener to affix the light engine to the head-mounted device at the particular alignment set by the flexure.

### RELATED CASES

The present application claims priority to U.S. Provisional Application No. 63/648,079, filed on May 15, 2024, and incorporates that application by reference in its entirety.

### FIELD

The present invention relates to alignment, and more particularly to aligning components which may have variances due to manufacturing and/or assembly tolerances.

### BACKGROUND

Mass produced Light Engines (LE's) have a projection axis that vary a few degrees from the nominal angle due to manufacturing and assembly tolerances of the system. This is called boresight error. The LE's also have position and angle tolerances that deviate from the designed nominal when installed into the wearable product or next higher level assembly. In addition to the LE tolerances, the waveguide in the binocular assembly of the product may also have angular deviation from the designed nominal due to the manufacturing tolerances of their mounting surfaces. These errors accumulate causing the virtual image projected from the wearable product to deviate from its intended position when viewed by a user. The cumulative deviation of each eye's projected image in a binocular system can be great enough to cause eye fatigue, discomfort, or an inability for the user to converge both projections into a single image.

One current solution is to align the images using digital offsets of the image on the display while viewing the left and right images via cameras that are calibrated to align the virtual image to the same target position. Another current solution method is to align the LE to each individual waveguide and fix them together in a monocular subassembly prior to installing them to the binocular assembly of a product. The system is then aligned digitally again to set the binocular alignment.

The drawbacks to these methods are a reduction of useable Field of View (FOV) because the digital correction requires giving up some portion of FOV to use pixels at the border for the digital offsets during alignment. Furthermore, the monocular subassembly design adds to the size, mass, and assembly complexity of a wearable device.

### BRIEF DESCRIPTION OF THE FIGURES

The present invention is illustrated by way of example, and not by way of limitation, in the figures of the accompanying drawings and in which like reference numerals refer to similar elements and in which:

FIGS. 1A and 1B illustrate one embodiment of a light engine and boresight, showing the projected ray bundle.

FIG. 2 illustrates the effect of binocular error.

FIGS. 3A-3C are different views of one embodiment a frame for pair of glasses including light engines.

FIG. 4A is an overview diagram of one embodiment of the mechanical attachment using a flexure.

FIG. 4B is a diagram of one embodiment of yaw, pitch, and roll adjustments.

FIG. 5A is an exploded view of one embodiment of the components of the design, including the light engine, a flexure, and the waveguide to which the light engine projects.

FIG. 5B is a side view of one embodiment of the assembly of FIG. 5A.

FIG. 6 illustrates an exploded view of one configuration of the system including a flexure and support structures for the flexure.

FIGS. 7A-7B illustrate one embodiment of a flexure, showing the rotation ability.

FIGS. 8A-8B illustrate the translation ability of the flexure of FIGS. 7A-7B.

FIGS. 9A and 9B illustrate various configurations of a metal flexure.

FIG. 10A illustrates an embodiment of a wireform flexure.

FIG. 10B illustrates an embodiment of a polymer flexure.

FIGS. 11A-11C illustrate an alternative configuration of a flexure.

FIGS. 12A-12B illustrate another alternative configuration for a flexure.

FIGS. 13A-13C illustrate one configuration of a removable flexure.

FIGS. 14A-14C illustrate various alternative attachment mechanisms for the removable flexure.

FIG. 15 illustrates a simplified configuration of an alignment station where a component can be aligned using the flexure.

FIGS. 16A-16B illustrate one embodiment of a binocular alignment station including a manipulator.

FIG. 17 illustrates embodiments of an integrated adjustment element for use by the alignment station.

FIG. 18 illustrates one embodiment of an integral adjustment mechanism, enabling adjustment of the alignment after installation.

FIGS. 19A-19C illustrate various embodiments of actuators that may be used for fastening the component after adjustment.

FIGS. 20A-20B illustrate embodiments of the fastening mechanism for the light engine.

FIGS. 21A-21C illustrate embodiments of using the system with a waveguide attachment.

FIGS. 22A-22B illustrate an alternative set of embodiments of using the system with a waveguide attachment.

FIG. 23A is a flowchart of one embodiment of attaching and adjusting a component using a flexure.

FIG. 23B is a flowchart of one embodiment of using the alignment station with a removable flexure.

### DETAILED DESCRIPTION

A flexure-based mechanical attachment permits the accurate alignment of components which may have variations, such as light engines. This may be particularly useful for binocular alignment, for head-mounted devices, such as goggles or glasses, where the goal is to minimize weight. This alignment system eliminates the extra components required for monocular alignment prior to binocular assembly of a product and maximizes the usable FOV of the light engines (LE) while aligning the converged image to a target position.

The method of alignment uses a flexure as part of the mounting process. The flexure provides the ability to move the component during the attachment process providing six degrees of freedom, to ensure correct alignment of the component, and then enables fixing the component in the correct alignment position.

Using the flexure in the mounting of a light engine allows the light engines and waveguides to be assembled into a smaller, lighter assembly. The assembly can be tested for function prior to performing the alignment process and is capable of achieving and maintaining the binocular alignment of the converged image within tolerances that are comfortable for the user of the device.

In one embodiment, an external actuating mechanism is used to align the components, with the flexure providing flexibility to adjust the alignment during the assembly. The external actuating mechanism may be a magnet, vacuum, tab, or other element that is used to move the component within the flexure for alignment.

The components are then fixed in the aligned position using a fastener. The fastener may be a mechanical fastener such as a screw, a wedge, a shim, a clip, or bolt. The fastener may be a chemical fastener, such as an adhesive or epoxy. In one embodiment, a UV-curable epoxy is used. In another embodiment, a moving mechanical fastener such as an actuator may be added to the assembly to affix the component once it is correctly aligned.

In one embodiment, the flexure is removed once the alignment is complete, and the component is attached and affixed in the correct position. In another embodiment, the flexure is integral with the component. In another embodiment, the flexure remains part of the assembly.

Using a flexure provides the ability to correctly align components such as light engines, waveguides, to a support structure, etc. This reduces the need to adjust the image data for alignment. In one test, the flexure-aligned light engine had a less than 1 pixel offset, requiring no adjustment to the image for alignment.

In one embodiment, the light engine uses a LCOS (liquid crystal on silicon) display. In another embodiment the light engine uses a microLED display.

The following detailed description of embodiments of the invention make reference to the accompanying drawings in which like references indicate similar elements, showing by way of illustration specific embodiments of practicing the invention. Description of these embodiments is in sufficient detail to enable those skilled in the art to practice the invention. One skilled in the art understands that other embodiments may be utilized, and that logical, mechanical, electrical, functional, and other changes may be made without departing from the scope of the present invention. The following detailed description is, therefore, not to be taken in a limiting sense, and the scope of the present invention is defined only by the appended claims.

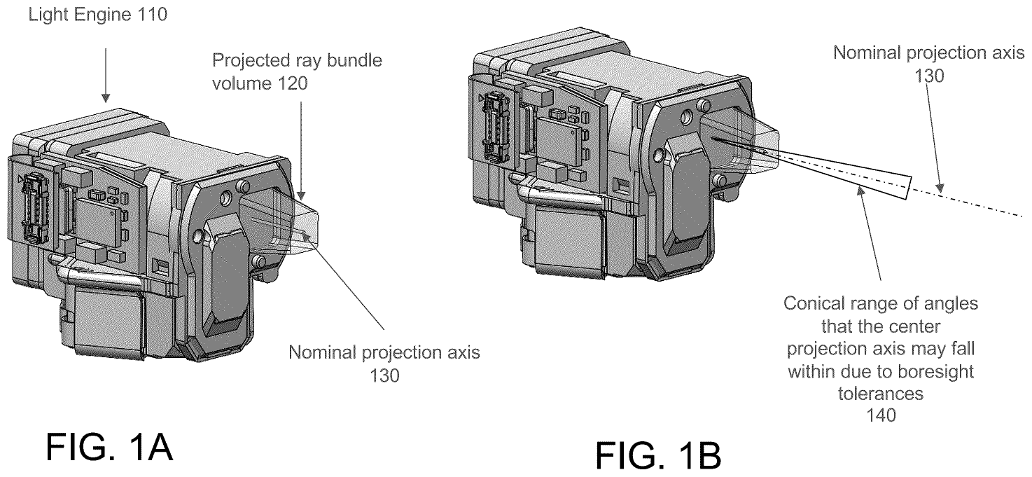

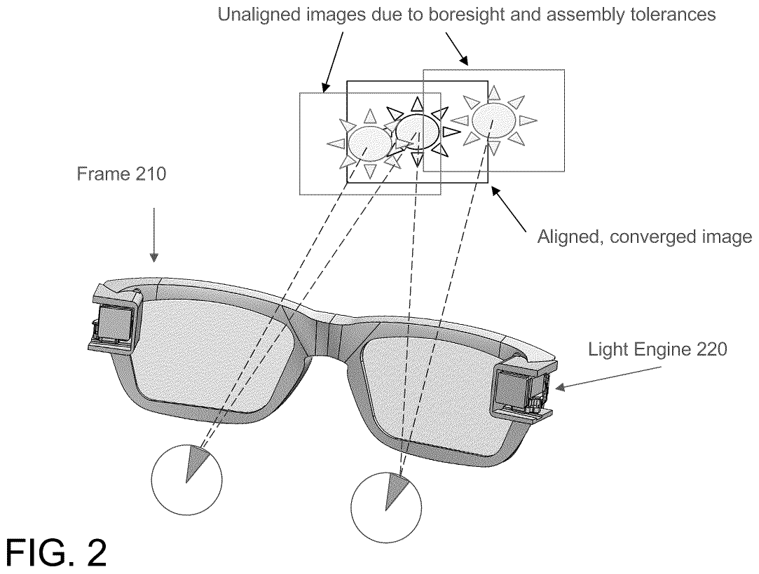

FIGS. 1A and 1B illustrate one embodiment of a light engine and boresight, showing the projected ray bundle. The light engine 110 projects a bundle of light. The light may be modulated or pass through one or more optical elements and then is displayed to a user. The light has a nominal projection axis 130 but actually is a bundle of light 120. The conical range 140 shows an exemplary range of angles that the nominal projection axis may fall within due to boresight/device tolerances. As can be seen, there is a significant range. If the nominal projection axis of the light engine for the right and left eyes are different, this can result in binocular error. FIG. 2 illustrates the effect of binocular error in display glasses in a frame 210 including two light engines 220. The unaligned images due to boresight and assembly tolerances would cause the viewer to not see the image, and either have double vision or not see a coherent image at all. In addition to not correctly forming the image, unaligned images can cause headaches and other issues due to the eyes being confused.

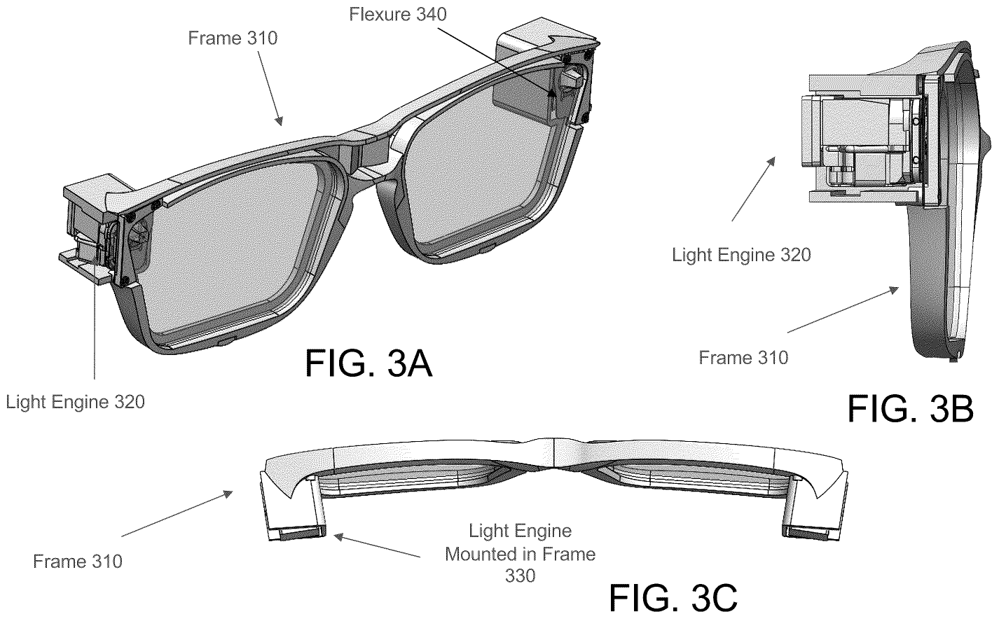

FIGS. 3A-3C are different views of one embodiment of a frame for a pair of glasses including light engines. The frame includes two light engines 320, on either side of the frame 310, one for each eye. The light engine is mounted in the frame, in a light engine mount 330. The flexure 340 provides the flexibility in the mounting that enables the adjustment of the angle of the light engine 320 to account for the boresight tolerances and cumulative tolerances of the light engine. This allows the resulting image to be correctly aligned, even if the light engines 320 are not perfectly matched. It can also be used to account for tolerances in the frame 310, or inaccuracies in assembly. Although a simple frame is illustrated in this case, the actual frame may have any configuration.

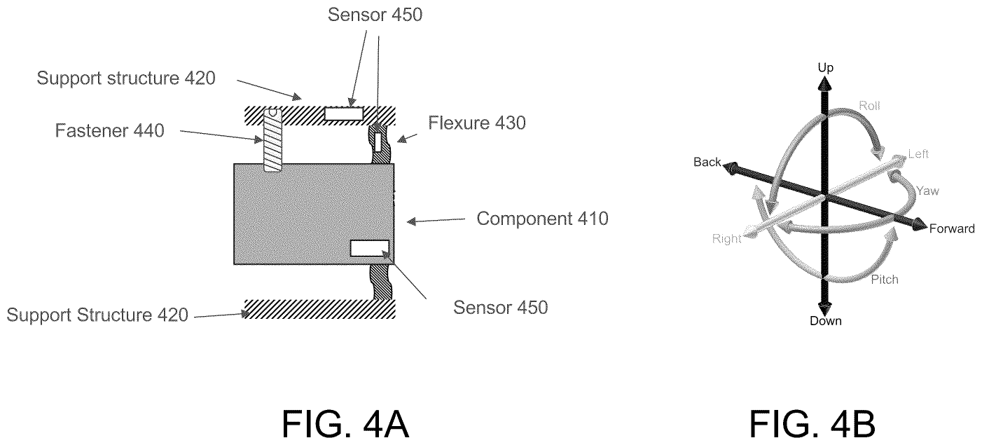

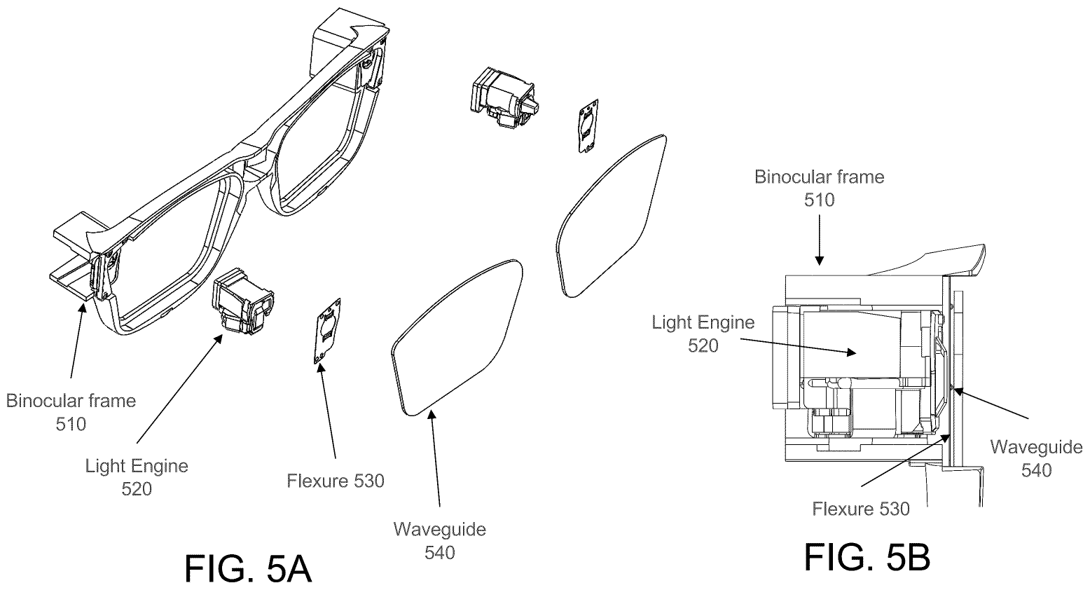

FIG. 4A is an overview diagram of one embodiment of mechanical attachment using a flexure. The system includes a component 410 coupled to a support structure 420, with a flexure 430 providing flexibility in the angle of the component 410. A fastener 440 is used to affix the component 410 to a non-adjustable portion of the device, referred to as the support structure 420, once it has been moved to the correct position. In this simplified illustration, the support structure 420 is illustrated as being above and below the component 410. However, in various configurations, the support structure may be in any configuration with respect to the component 410.

The support structure 420 provides a fixed structure to which the component 410 can be secured by fastener 440, to maintain the orientation which was achieved using flexure 430. The support structure 420 may be a frame, a fixed waveguide, or another structure. The component 410 may be a light engine, waveguide, steering or turning prism, eye tracking sensors, or other optical element whose alignment with respect to an angle should be controlled. The flexure 430 may remain in place after alignment or may be removed after the fastener 440 is applied. The fastener 440 may be a screw, an actuator, glue, or another type of fastener to fix the component 410 in the aligned position.

In various embodiments, the system may also include one or more sensors 450 to monitor the system's alignment. A sensor may be placed on, or part of, the support structure, flexure, and/or component. The sensor may include one or more of: a gyroscope, accelerometer, an inertial sensor (inertial measurement unit), a strain gauge, optical sensor, camera, or other sensor to provide on-going information about changes to the structure which would cause misalignment. The sensor enables the system to detect when the support structure or component are bent or out of alignment.

The output of the sensor may be analyzed by a processing system within the wearable or external to the wearable, to determine whether the system has become misaligned. This may trigger an indication that the system should be assessed to realign the light engine. In some embodiments, the misalignment may be used to adjust the image generated, to account for the misalignment and retain convergence.

FIG. 4B illustrates the six degrees of freedom provided by the flexure. The movement available to the component includes yaw, pitch, and roll. In various embodiments, the component can move up to 10 degrees in each dimension, to provide flexibility in adjusting the position of the nominal projection axis for convergence.

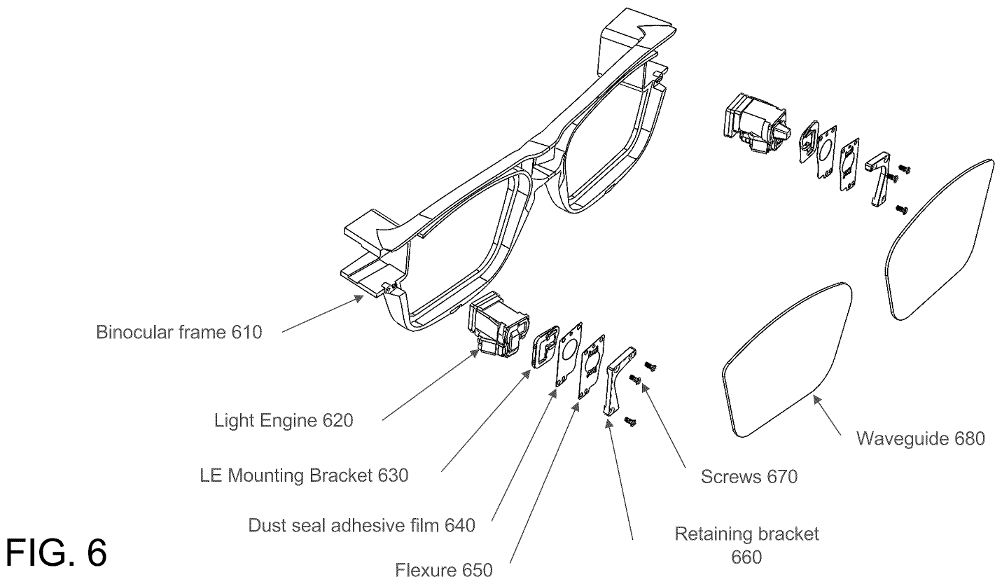

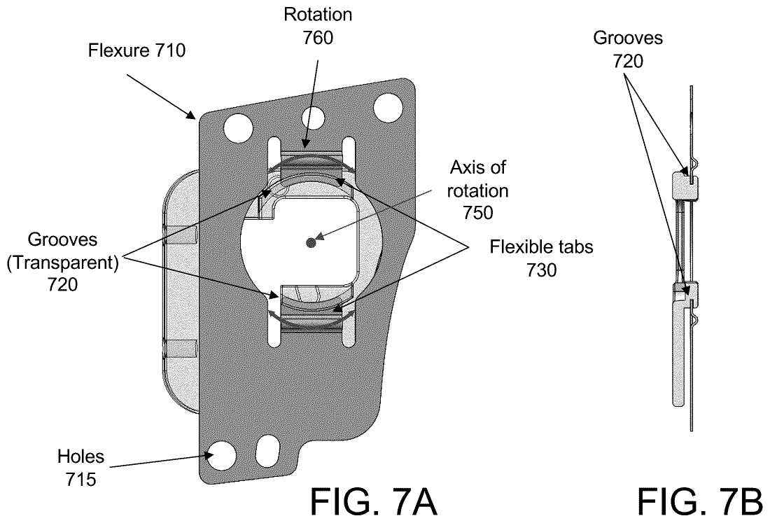

FIG. 5A is an exploded view of one embodiment of the components of the design, including the light engine, a flexure, and the waveguide to which the light engine projects. The binocular frame 510 includes two light engines 520, on either side of the frame. Each light engine 520 includes an associated flexure 530, which enables the light engine angle to be adjusted. The light output by each light engine 520 is coupled into a waveguide 540, which is used to display the image. The waveguide 540 is coupled to the binocular frame 510 and serves as the “lens” in the frame. The output of light engine 520 is oriented to have the proper alignment with respect to an in-coupler of waveguide 540. FIG. 5B is a side view of one embodiment of the assembly of FIG. 5A. As can be seen, the frame 510 provides a support structure for the light engine 520, which is affixed within the frame using flexure 530. The light engine 520 may be coupled to the frame 510 and/or the waveguide 540.

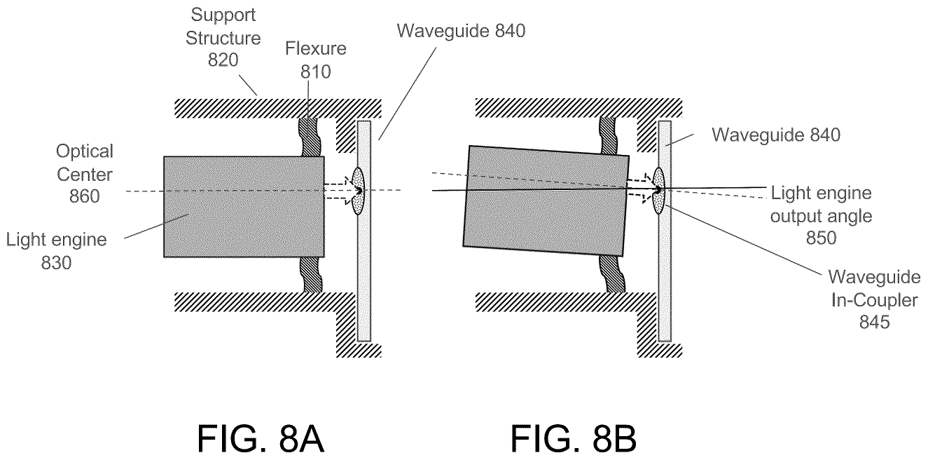

FIG. 6 illustrates an exploded view of one configuration of the system including a flexure and support structures for the flexure. The binocular frame 610 includes the light engine 620, flexure 650, and waveguide 680, as discussed above. In addition, the support structure for flexure 650 includes in various embodiments a retaining bracket 660 to add stiffness and structure to the flexure 650, a dust seal adhesive film 640 to keep any dust or particulate from the light engine, and the light engine mounting bracket 630. The retaining bracket 660 is coupled to the light engine mounting bracket 630 using screws 670, in some embodiments. Other attachment mechanisms, such as glue, may be used instead of screws 670.

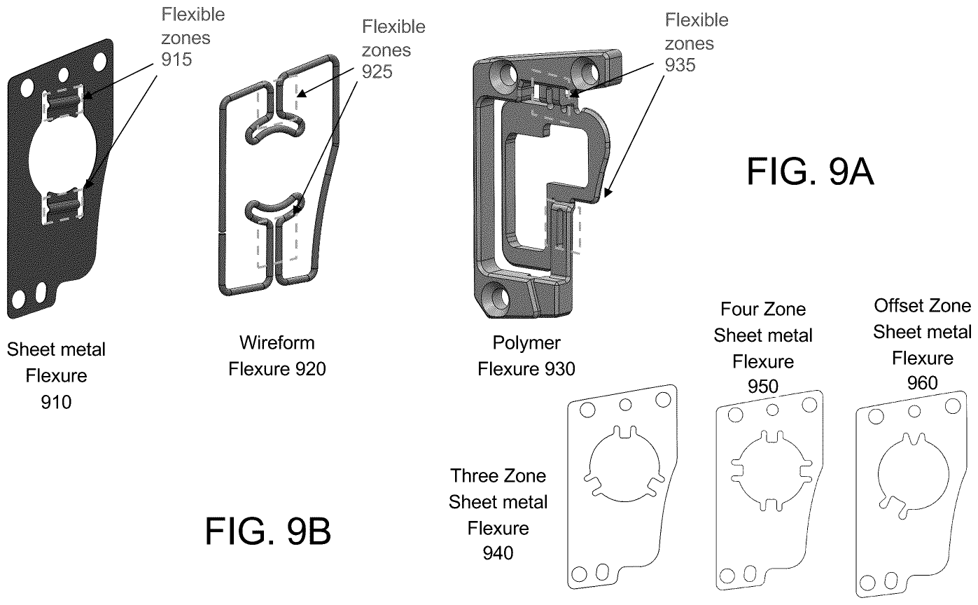

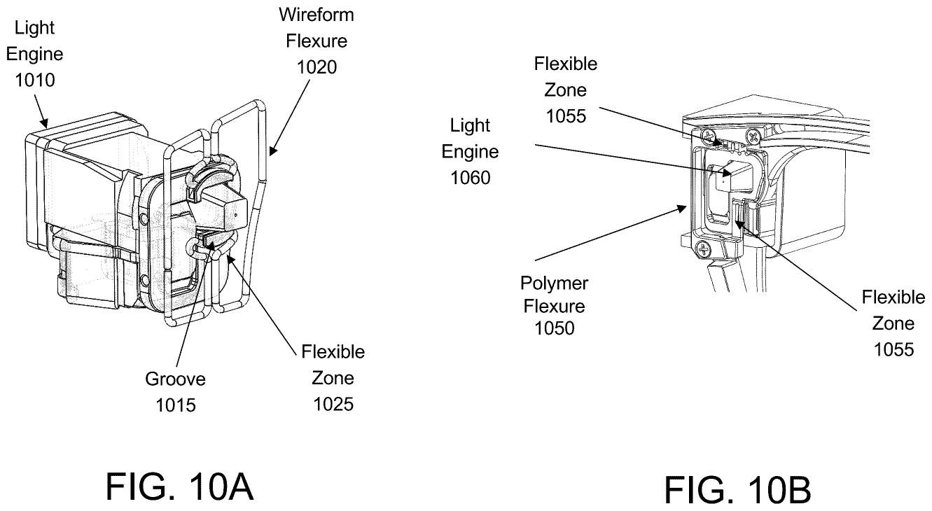

FIGS. 7A-7B illustrate one embodiment of a flexure, showing the rotation ability, while FIGS. 8A-8B illustrate the translation ability of the flexure. These figures together illustrate the ability to adjust in all six dimensions, e.g., the roll, yaw, and pitch movements available to the component through the flexure. The flexure 710 includes flexible tabs 730 which in various embodiments are designed to fit into grooves 720 associated with the light engine. The flexible tabs 730 allow rotation 760 of the light engine, as well as other movements. The positioning of the grooves 720 is more clearly visible in FIG. 7B. The flexure 710 rotates around an axis of rotation 750. In some embodiments, the center of the projection axis does not move as the light engine within the flexure 710 is rotated. In some other embodiments, the flexure is positioned off-center from the nominal projection axis, and rotation causes movement of the projection axis. The flexure 710 can also include holes 715 to affix the flexure to a support structure. In various embodiments, the flexure is spring-like, temporarily deformed by the movement of the light engine, but springing back to its original shape when released. The light engine position is locked-in using a fastener (not shown) once the correct pitch, yaw, and roll are set. In another embodiment, the flexure 710 may be flexible but deformable, such that once it is moved into a configuration, it remains in that configuration. In such configurations, the system may eliminate the fastener. The flexure 710 may be made of a smart material which permits deformation, but locks into position based on characteristics, such as application or removal of a magnetic field, electric field, etc.

As shown in FIGS. 8A and 8B, the flexure 810 also provides the ability to change the pitch, yaw, and roll of the light engine 830, to alter the position of the output 850 of the light engine 830, and thus provide translation. Because the flexure tabs are flexible, the component 830 can be tilted to be at the correct alignment while being supported by the support structure 820 and flexure 810. In various embodiments, the flexure 810 provides an up-to 5 degree range for yaw/pitch movements. In another embodiment, up to a 10 degree range of motion may be provided in every direction. FIG. 8A illustrates the nominal position, where the light engine output angle 860 is normal to the waveguide 840, while FIG. 8B illustrates an exemplary tilted position, where the light engine output angle 850 is changed by moving the light engine 830, to better match the waveguide in-coupler 845. This provides adjustment for size and tolerance issues, ensuring that the output of the light engines are properly positioned for entry into a waveguide 840, and for convergence.

The output of the light engine 830 may be an input to a waveguide 840. In such embodiments, the flexure is designed such that the light engine 830 pitch, yaw, and roll are limited so that the light engine output angle 850 of the light engine 830 coincides with the waveguide in-coupler 845, through the entire range of positions. However, the intersection may be offset, rather than centered on the in-coupler 845.

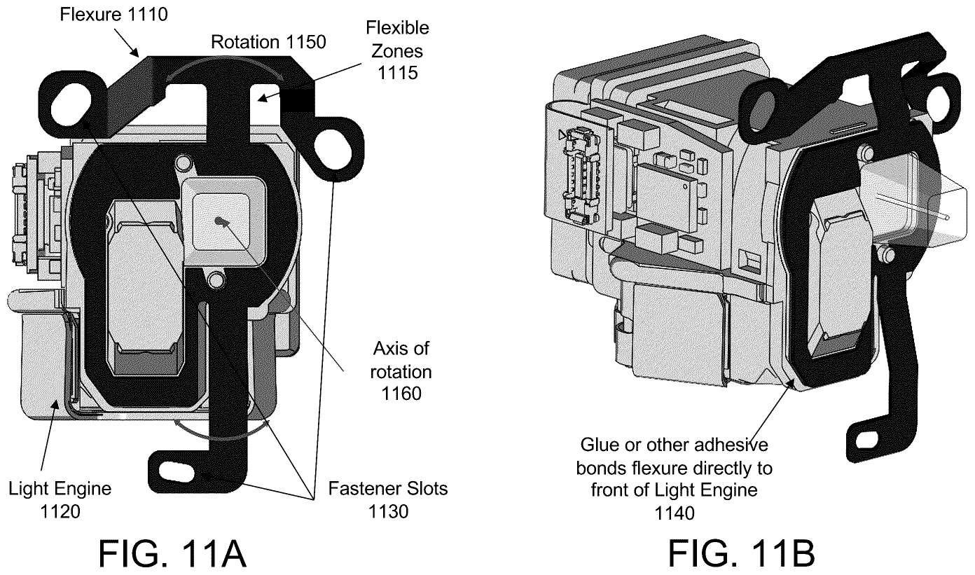

FIGS. 9A and 9B illustrate various configurations of a metal flexure. The flexure may be made from various materials, including steel sheet metal, metal wire, polymer, copper sheet metal, die cast or metal injection molded alloys, smart materials, etc. The flexure may include one or more of screw holes or other mechanisms for attaching the flexure, alignment features, as well as folds, ribs, slots or other features to provide flexibility for the flexible zones supporting the component.

Each of the flexure examples includes flexible zones 915, 925, 935 which provide yaw, pitch, and roll movements. The sheet metal flexure 910 includes tabs as flexible zones 915. The wireform flexure 920 includes shaped components with a wider tab supported by a narrower neck as flexible zones 925. The polymer flexure 930 provides thinner zones which provide flexibility, while other components of the flexure are thicker to provide rigidity. The number and position of the flexible zones may vary. As shown in FIG. 9B for the sheet metal flexure, the flexure may have three flexible zones 940, four flexible zones 950, or two flexible zones which are offset zones 960. A different number of flexible zones may be used as well. Additionally, such adjustments may also be made to a flexure made of a different material. The actual configuration of the zones and materials used is open, provided the flexure can support a component and provide yaw, pitch, and roll adjustments for the component, to permit correct alignment of the component.

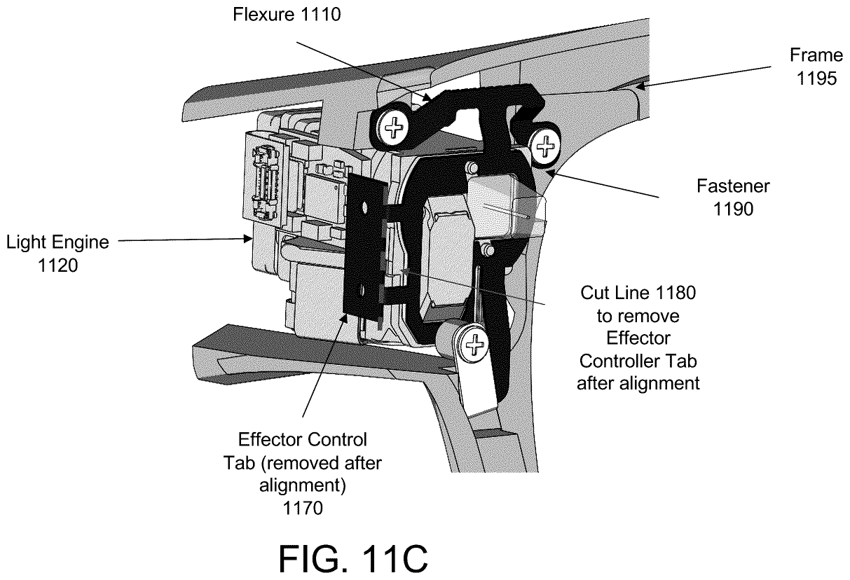

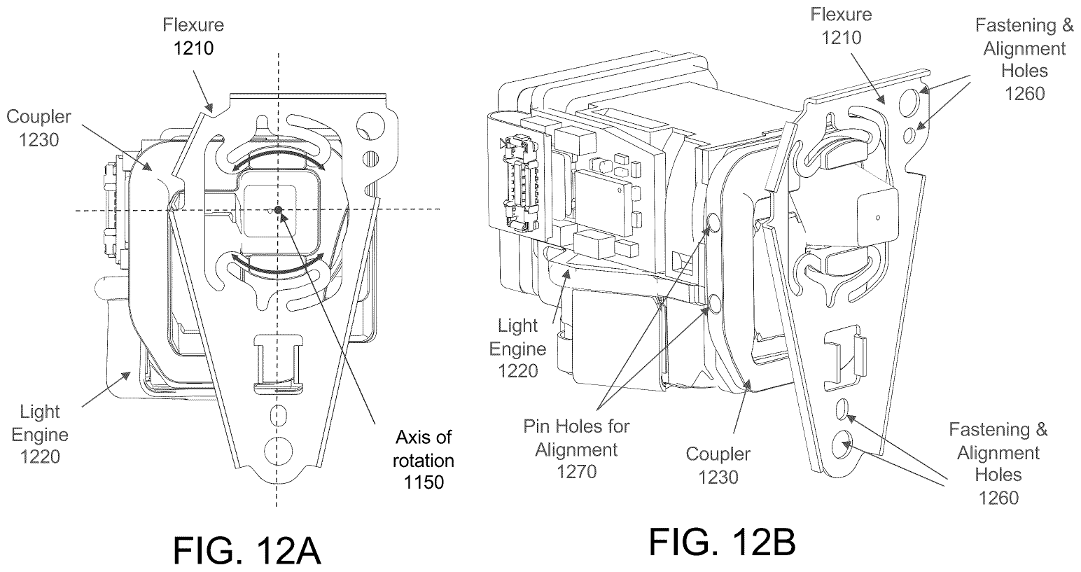

FIG. 10A illustrates an embodiment of a wireform flexure coupled to an exemplary light engine. The wireform flexure 1020 has flexible zones 1025 which fit into grooves 1015, to provide support for the light engine 1010. The grooves 1015 may be part of the light engine 1010 or may be a part coupled to the light engine. The wireform flexure 1020 is coupled to a support structure (not shown), and the light engine 1010 is coupled to a support structure once it is oriented properly. In various embodiments, the wireform flexure 1020 may include loops for screws. The wireform flexure 1020 may be made of a smart material, which can be adjusted using electricity, heat, or a magnetic field. The wireform flexure 1020 may also snap into a groove in the support structure, rather than be attached via screws or other such components.

FIG. 10B illustrates an embodiment of a polymer flexure coupled to an exemplary light engine. The polymer flexure 1050 has flexible zones 1055, which provide the ability to adjust the orientation of the light engine 1060. Using a polymer flexure 1050 may reduce the number of components in the system. In various embodiments, the polymer flexure 1050 incorporates a retaining bracket, mounting bracket, and flexible zones 1055 into a single plastic piece. In some embodiments, the polymer flexure may be integrated into the housing of the light engine itself, rather than being a separate component. In this configuration, the flexure that is part of the light engine housing provides flexible zones which enable partial attachment of the light engine to a support structure, adjustment of the light engine angle and orientation using the flexible zones 1055 of the flexure and then affixing the light engine in the adjusted position.

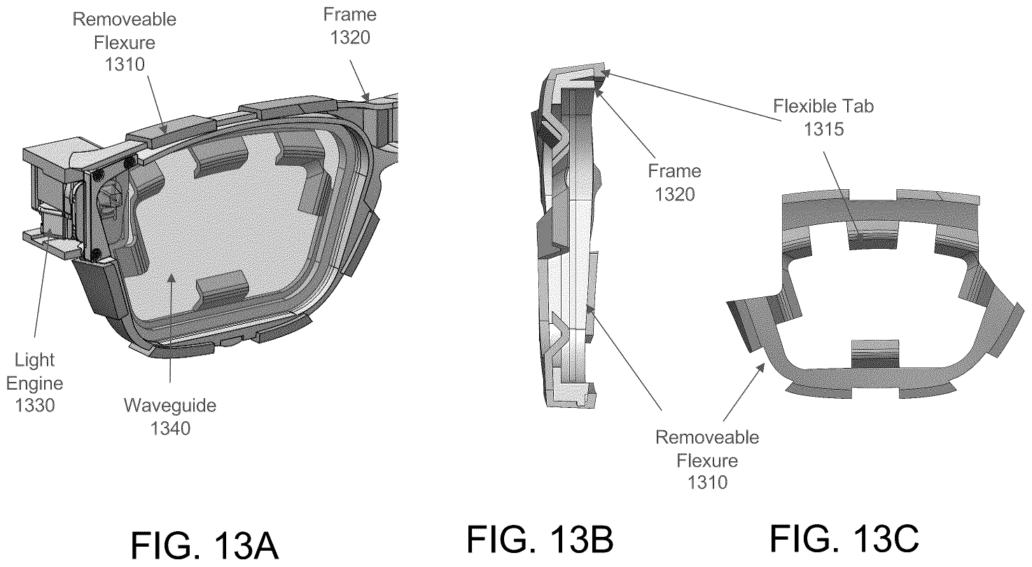

FIGS. 11A-11C illustrate an alternative configuration of a flexure. The configuration illustrated shows a flexure 1110 which is bonded directly to the front of the light engine. The attachment may be via a chemical attachment, such as glue 1140 or another adhesive. Alternatively, the attachment may be via a screw, a snap-in mechanism, or another type of attachment method. Thus, to rotate the light engine, the flexure 1110 is also rotated. The flexure 1110 includes fastener slots 1130 which are designed to allow the flexure 1110 to enable rotation 1150 around the axis of rotation 1160 of the light engine 1120 and the flexure 1110 coupled to it, so that the flexure 1110 can be fastened to a support structure (not shown) at a range of angles. As in the previous embodiments, the flexure has flexible zones 1115 which allow the yaw, pitch, and roll adjustments of the light engine. Once the position of the light engine has been adjusted, the flexure 1110 is coupled to the frame 1195 via fasteners 1190. In this illustration the fasteners 1190 are shown as screws, however fasteners may be screws or other types of mechanical fasteners, or glue or other types of chemical fasteners. In some embodiments, the fastener may include an effector control tab 1170, which can be used to position the light engine 1120 during alignment. The effector control tab in some embodiments, may be removed after alignment and fastening of the light engine at the aligned position, at a cut line 1180.

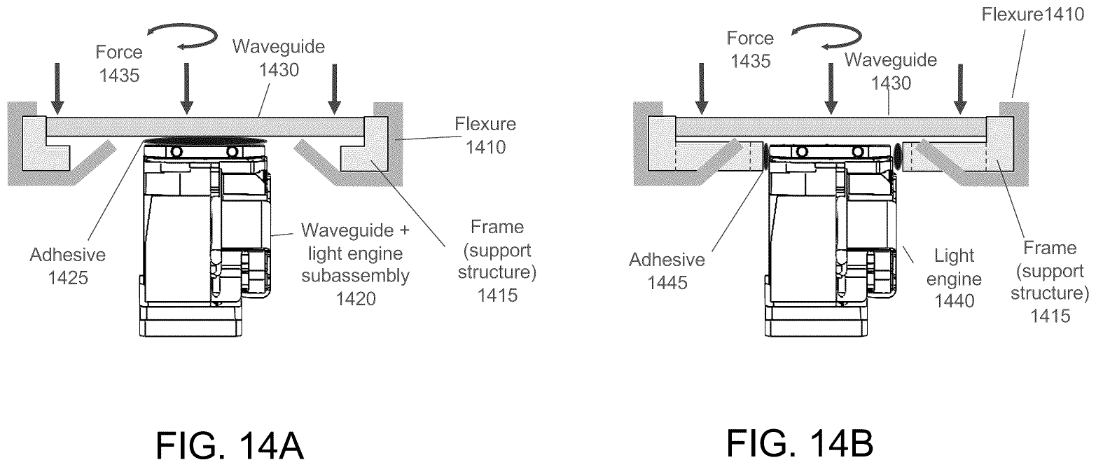

FIGS. 12A-12B illustrate another alternative configuration for a flexure. This configuration includes a flexure 1210, and a coupler 1230 attached to the light engine 1120. The coupler 1230 may be part of the light engine enclosure or may be a separate component coupled to the light engine. Rather than adjusting the angle and position of the light engine by controlling the movement of the flexure 1210 or the light engine 1220 directly, the alignment is done by moving the coupler 1230. The coupler may be moved using pin holes for alignment 1270. The flexure also includes fastening and alignment holes 1260 in various embodiments, so the flexure can be fastened to a structural component, after alignment. In various embodiments, as illustrated in FIG. 12A, the flexure positions the light engine optical axis at an offset with respect to the rotation. This offset assists in maximizing optical performance between light engine output and waveguide input, while ensuring a consistent force when moving the light engine through its range of motion. Optical performance metrics based on coupling efficiency may have an impact on brightness, color uniformity, and/or optical efficiency. The offset may change based on design choices such as optical characteristics of the waveguide, needed range of motion of the light engine supported by the flexure, as well as manufacturing and industrial design packaging considerations.

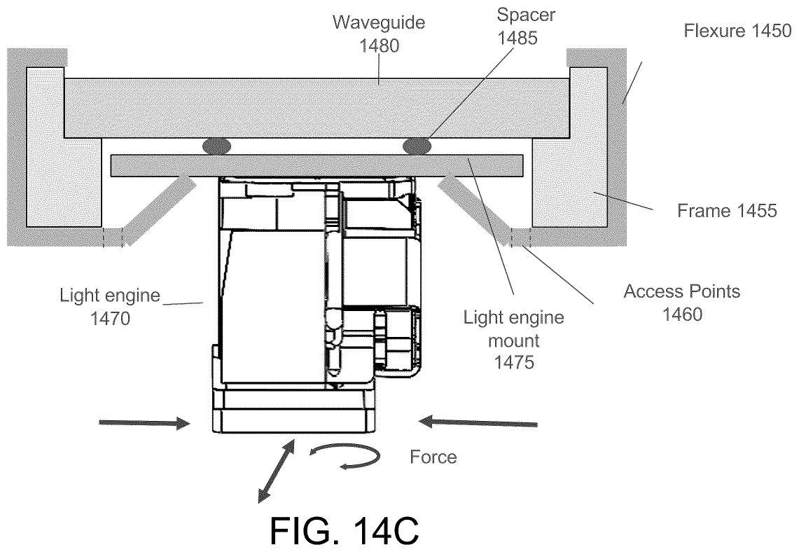

FIGS. 13A-13C illustrate one configuration of a removable flexure. A removable flexure 1310 is a temporary component which is added to the system for alignment of the light engine, enabling the adjustment of the rotation, tilt, and pitch of the light engine 1330 output, and then removed. The adjustment may be of the light engine 1330, or of a waveguide 1340, or other component into which the output of the light engine is coupled. The removeable flexure 1310 is coupled to a frame 132—or other support structure using snap-fit joints fitting over the frame edge. In various embodiments, the natural flexibility of the material used for the flexure 1310 is used to enable the flexure to be snapped onto the support structure or frame 1320. The flexure 1310 is temporarily and rigidly attached to the support structure during the alignment process. The flexure 1310 may be made of synthetic rubber such as silicone rubber, soft polymer rubber, sheet metal, or another material. The flexure 1310 includes one or more tabs 1315 that provide positioning support with flexibility and movement for the component for alignment. Although a flexure 1310 with six tabs is shown, the number of tabs may vary. In one embodiment, the number of flexible tabs is defined by the size of the component being aligned. In various embodiments, this flexure 1310 design may be used to align the waveguide, the light engine, and/or a subassembly including the waveguide and light engine which are secured to each other. The removable flexure 1310 may be removed after the component is affixed to the support structure in the aligned position.

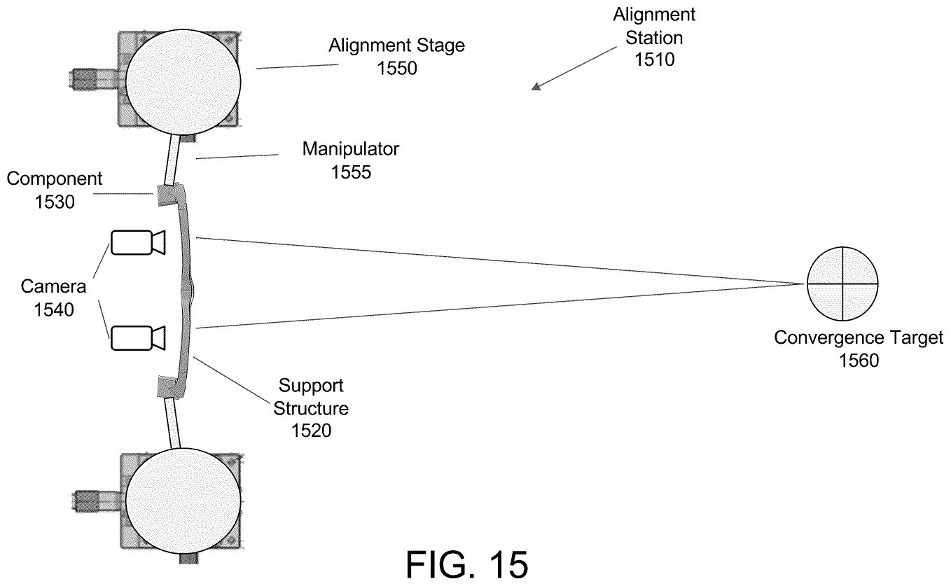

FIGS. 14A-14C illustrate various attachment mechanisms for a removable flexure. FIGS. 14A-14C illustrate different configurations in which the removable flexure 1410 attaches onto the frame and can be removed after the alignment. In FIG. 14A, the light engine is coupled to a waveguide using an adhesive or other attachment mechanism 1425, creating a waveguide+light engine subassembly 1420. The light engine and waveguide subassembly 1420 is aligned to a frame support structure 1415, using the flexure 1410. To adjust position, force 1435 can be applied via the waveguide, to adjust the relative position of the output of the light engine. Once the alignment is complete, the waveguide light engine subassembly is secured to the frame 1415, in the aligned position. The flexure 1410 can be removed at that point.

FIG. 14B illustrates a configuration in which the light engine 1440 is securely coupled to the frame support structure 1415, via adhesive 1445 or another secure attachment mechanism. The waveguide 1430 position is adjusted using flexure 1410. Once the waveguide 1430 and light engine 1440 are correctly aligned, the waveguide is securely fastened to the frame 1415. The flexure 1410 can be removed at that point.

FIG. 14C illustrates a configuration in which a light engine mount 1475 is rigidly attached to a light engine 1470. In one embodiment, a flexure 1450 is used to align the light engine and engine light mount unit with the frame 1455. The flexure 1450 attaches to the frame. The light engine and frame mount can be moved using the flexure. The flexibility may be provided by a combination of the flexure 1450 and spacers 1485, which allow the light engine mount 1475 to move closer or further from the waveguide 1480 for alignment. Once the light engine 1470 is correctly aligned with its output to the in-coupler of the waveguide 1480, the light engine mount 1475, and thus the rigidly coupled light engine 1470 are coupled to the frame 1455. In various embodiments, the flexure 1450 may include access points 1460 through the flexure 1450, to provide access for applying glue between the frame 1455 and the light engine mount, once the light engine is properly aligned. The flexure 1450 can be removed, after the light engine mount 1475 is securely fixed to the frame 1455 and/or the waveguide 1480.

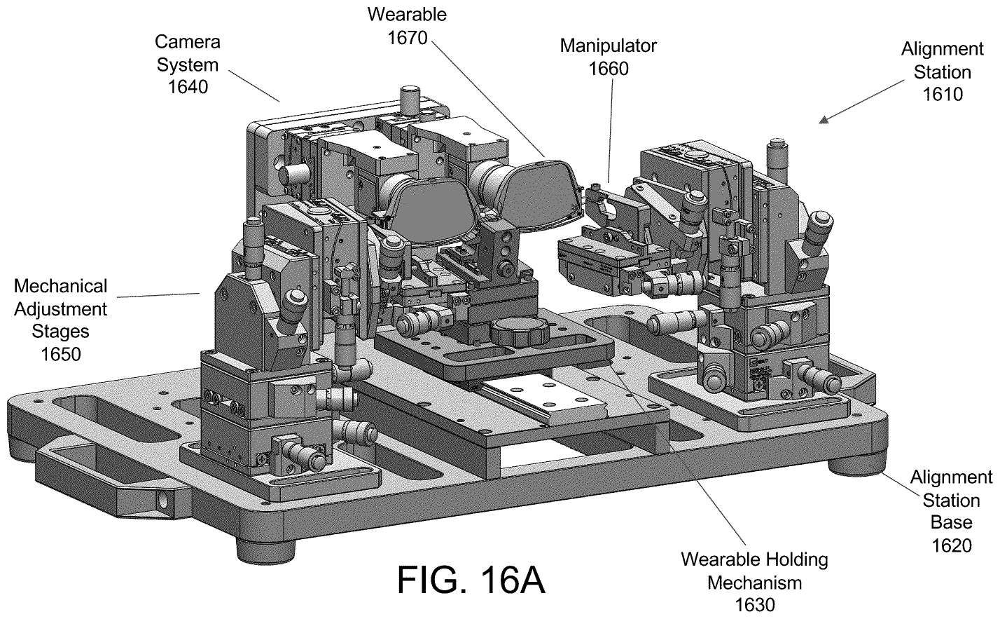

FIG. 15 illustrates a simplified configuration of an alignment station where components can be aligned using the flexure. The alignment station 1510 includes a holder for the frame or support structure 1520, which includes a component 1530 for alignment. The system in various embodiments further includes camera 1540. The camera 1540 is focused on a convergence target 1560, at a distance at which the images from the two light engines should converge to correctly form an image for viewing by a user. On each side of the support structure 1520, there is a manipulator 1555, controlled by alignment stage 1550, to adjust the alignment of the components. As discussed above, this adjustment may be of the component, a mount or coupler, and/or the waveguides into which the component's output is directed. As the alignment of the components is adjusted, the effect on the output can be observed by cameras 1540. The manipulator 1555 may include an end effector which engages with an interface on the component, flexure, mount, and/or coupler via a magnet, a tab, a vacuum, or another mechanism for moving the component to the correct alignment. The movement of the manipulator 1555 may be automatic or controlled by a user.

In various embodiments, the support structure 1520-in one embodiment a waveguide and frame sub-assembly-is loaded onto a framework in front of two cameras 1540. On each side, a light engine 1530 is mounted on an end effector on a manipulator 1555 that is attached to an alignment stage 1550. The alignment stage 1550 allows positional adjustment of the light engine 1530 until the image projected from each light engine lines up with the convergence target that the cameras 1540 see.

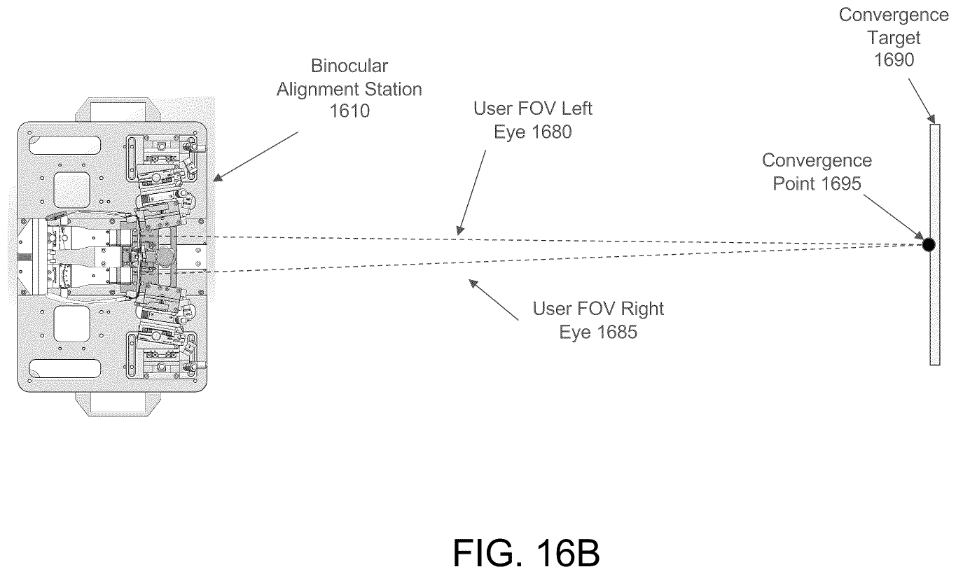

FIGS. 16A-16B illustrate one embodiment of a binocular alignment station including a manipulator. The station 1610 is held on a base 1620 and includes a wearable holding mechanism 1630 which securely holds the support structure, which may be a frame. The wearable 1670 shown is an augmented reality display which includes a frame, two lenses including waveguides, and associated light engines which should be aligned to ensure that the image seen by the user converges appropriately. The convergence is determined by camera system 1640, which determines the alignment by looking through the waveguide, duplicating the view seen by a human wearer of wearable 1670. The mechanical adjustment stages 1650 provide a manipulator 1660 to interact with the component to be aligned. As noted above, the component to be aligned may include one or more of a light engine, another optical component, a waveguide, or different component which may be used to control how the image is displayed to a user.

As shown in FIG. 16B, a convergence target 1690 at a distance including a convergence point 1695 enables the cameras 1640 to determine whether the light engines are properly aligned, so that the user's field of view for the left eye 1680 and the right eye 1685 converge correctly, to display an image. In some embodiments, the convergence target 1690 may be positioned closer to the binocular alignment station 1610 by using one or more mirrors to fold the view.

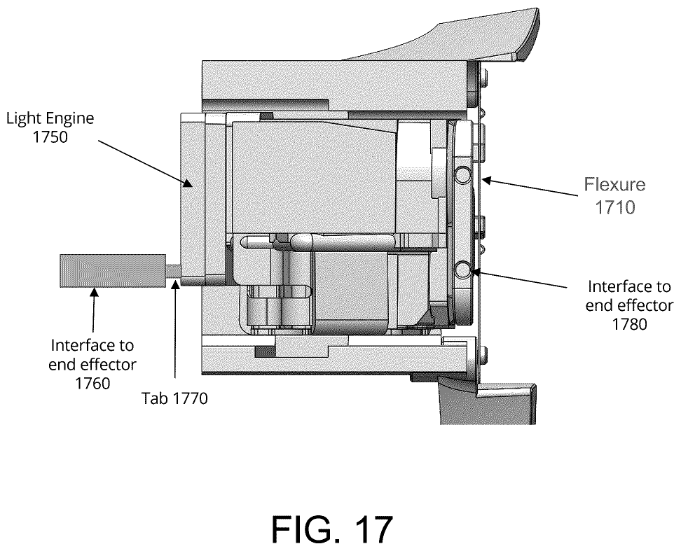

FIG. 17 illustrates one embodiment of an integrated adjustment element for use by the alignment station. The manipulators of the alignment station interact with the light engine, waveguide, and/or light engine mount using an adjustment element, in various embodiments. In various embodiments, adjustment elements integral to the component may be used to provide movement to align the component. In some embodiments, such integral adjustment elements can replace the adjustment station discussed above.

FIG. 17 illustrates two alternative configurations for the interfaces, a back interface 1760 coupled by tab 1770 to the back of the light engine 1750, and a front interface 1780 in a light engine mount. The system may include one or both of these adjustment mechanisms. In some configurations, the back interface 1760 may be removed after the alignment is complete by breaking the interface off at tab 1770.

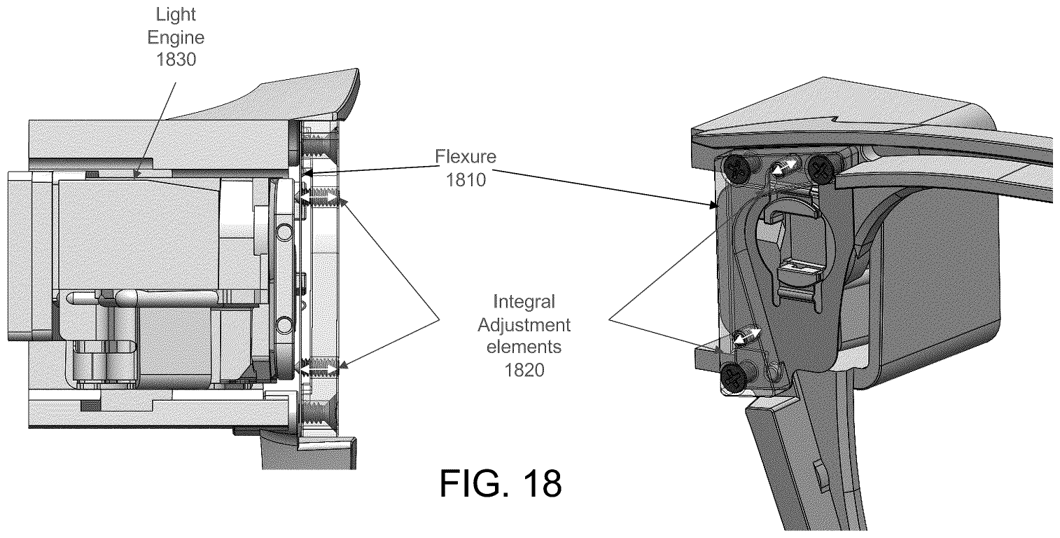

FIG. 18 illustrates one embodiment of an integral adjustment mechanism, enabling adjustment of the alignment after installation. The adjustment elements 1820 are set screws which provide pressure against the flexible tabs of the flexure 1810, to cause the angle of the light engine 1830 supported by the flexure 1810 to change. integral adjustment elements 1820 In various embodiments, the integral adjustment mechanisms 1820 may be manipulated by the adjustment station discussed above. In various embodiments, screws or other integral adjustment elements 1820 can interface with the component from the front, the back, or any other area. The inclusion of screws or other integral adjustment elements 1920 integral to the mechanism allows for direction actuation without the need for external adjustment fixturing. Furthermore, these integral adjustment elements 1820 may permit a subsequent readjustment of the alignment of the component, in various embodiments. Over time, as the wearable is used, components may warp or wear, causing misalignment. If an integral adjustment element 1820 is used, such as a screw, the alignment may be readjusted at that point, using an alignment station, or manual controls. When the fastening is done using glue or similar permanent mechanisms, no subsequent adjustment is possible.

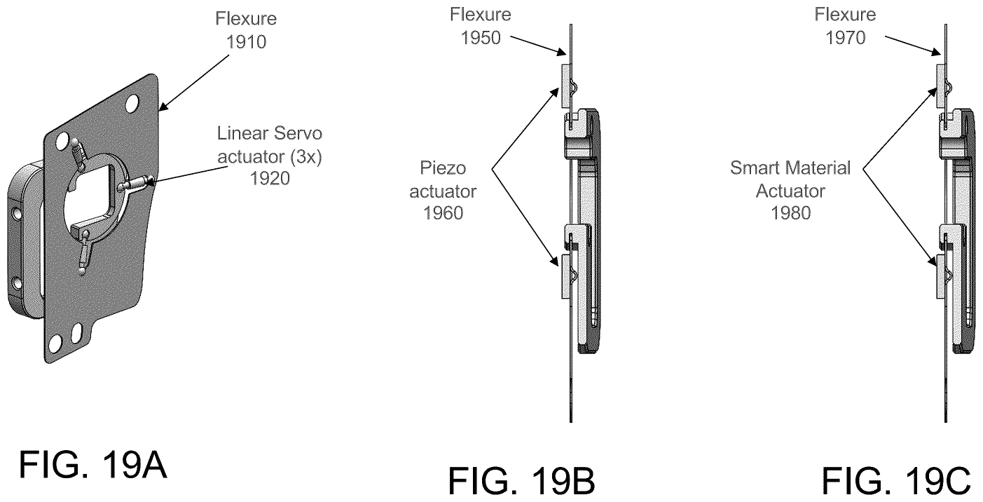

Another way to make subsequent adjustments possible is illustrated in FIGS. 19A-19C, which illustrate embodiments of an actuator that may be used for fastening the component after adjustment.

FIG. 19A illustrates linear servo actuators 1920 may be integrated into flexure 1910, and act as fasteners. In various embodiments, the linear servo actuators 1920 are self-locking linear actuators, also referred to as zero hold power actuators, which, when not powered, are in a holding position and resist movement. By applying power, the position of the linear actuator 1920 may be altered. In this configuration, the system temporarily applies power to the linear actuators 1920 during the alignment process and removes power after the alignment process to lock the actuator, and thus the component, in place.

In various embodiments, the flexure 1910 includes a linear servo mechanism 1920. A servo driven alignment can hold its position after power is turned off, avoiding the need to use separate glue or another fixing device.

FIG. 19B illustrates an alternative actuator, which is a piezo element 1960 attached to the flexure 1950 to cause the flexible tabs to bend.

FIG. 19C illustrates a third configuration of an actuator, in which a smart material is used as the actuator. The smart material actuator 1980 coupled to flexure 1970 may be made of a shape memory alloy, such as nitinol, which alters shape based on temperature, or another smart material, which alters its shape based on an electric or magnetic field. Other embodiments may have these actuators push/pull on the component in another location (near the back for example) and utilize the simple flexure illustrated in other figures.

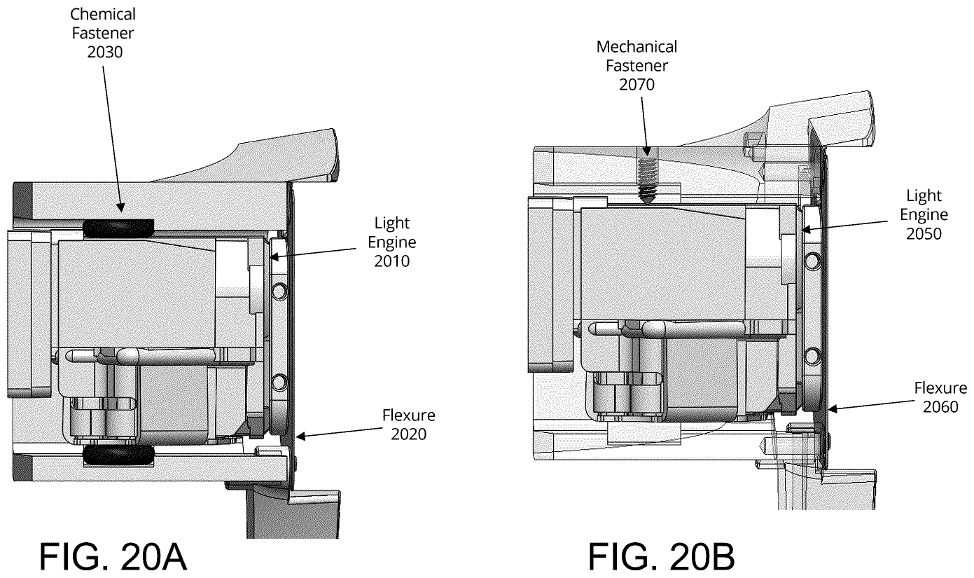

FIGS. 20A-20B illustrate embodiments of the fastening mechanism for the light engine. FIG. 20A illustrates an adhesive 2030 used as a fastener, holding the light engine 2010 in position once it is correctly aligned via flexure 2020. In various embodiments, the adhesive 2030 may be a UV-cured adhesive, which is applied prior to the alignment, and cured after the alignment is done while the alignment station is keeping the light engine 2010 in the aligned position.

FIG. 20B illustrates a screw used to fasten the light engine 2050 to the frame once it is correctly aligned using flexure 2060. The fastening of the light engine may be done via adhesives, actuators, screws, or other mechanisms. Although the illustration shows the fastener being on the top of the component (screw 2070), or the top and bottom of component (adhesive 2030), it may be in any location, including the front of the component. The only limitation is that the fastening can be completed when the light engine is being held in the aligned position. But as noted with respect to the adhesive, the completing of the fixing of the position may be curing a previously applied adhesive, rather than having access to the particular location. In some embodiments, the system may include an integral set screw, or actuators, which remove the need for a separate element for fastening.

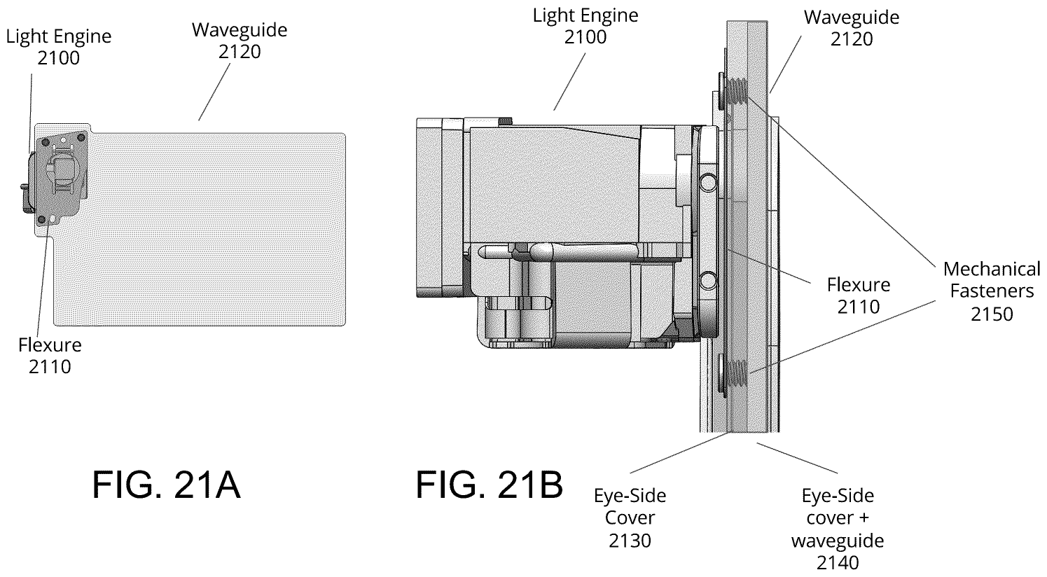

FIGS. 21A-21C illustrate one embodiment of using the system with a waveguide attachment. In one embodiment, the flexure 2110 may be coupled to a waveguide 2120, rather than a frame. In various embodiments, the flexure 2110 may be coupled directly to molded eye-side covers (or plastic lenses) 2130 that are laminated to the waveguides 2120—forming a molded cover plus waveguide unit 2140. These eye-side covers (push/pull lenses) 2130 are used with the waveguides 2120, and in one embodiment may include features to enable coupling the flexure 2110 to the eye-side covers 2130. In this illustration that mechanism includes screws 2150 which affix the flexure 2110 to the cover 2130. This eliminates the need for a separate bracket piece. It also removes the reliance on the frame. Because the output of the light engine 2100 is an input to the waveguide 2120 by coupling the light engine 2100 to the waveguide 2120, the risk of warping of the lens causing a misalignment is eliminated. Any warping in the waveguide 2120 would destroy convergence and the ability to display images at all, so that is not an issue.

FIG. 21C illustrates a configuration in which a chemical fastener 2160 is used, instead of a mechanical fastener, to couple the flexure 2110 to the eye-side cover 2130 and waveguide 2120. The chemical fastener 2160 may include epoxy, adhesives, or other chemical attachment mechanism. The chemical fastener 2160 may be optically matched to the lens.

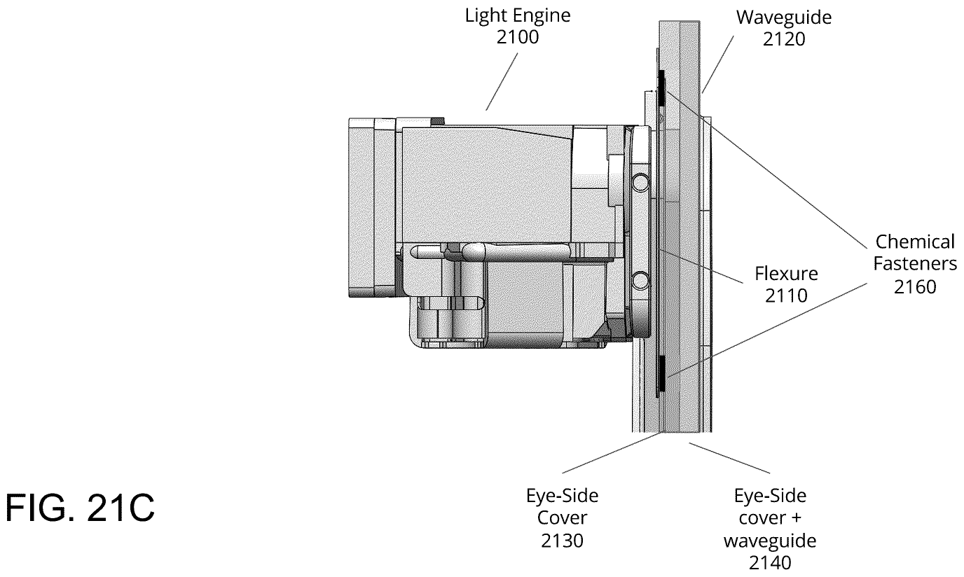

FIGS. 22A-22B illustrate an alternative set of embodiments of using the system with a waveguide attachment. In this configuration the light engine 2200, 2250 is coupled to the flexure 2210, 2270. In turn, the flexure 2210, 2270 is fastened to the waveguide 2220, 2260 or the structure supporting the waveguide. The fastening may be via mechanical fasteners 2240 or chemical fasteners 2280.

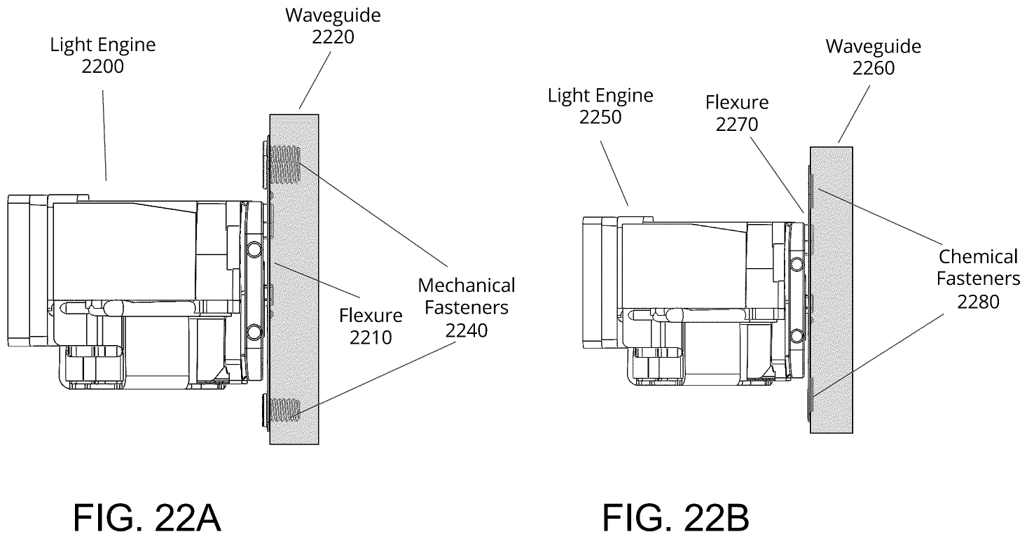

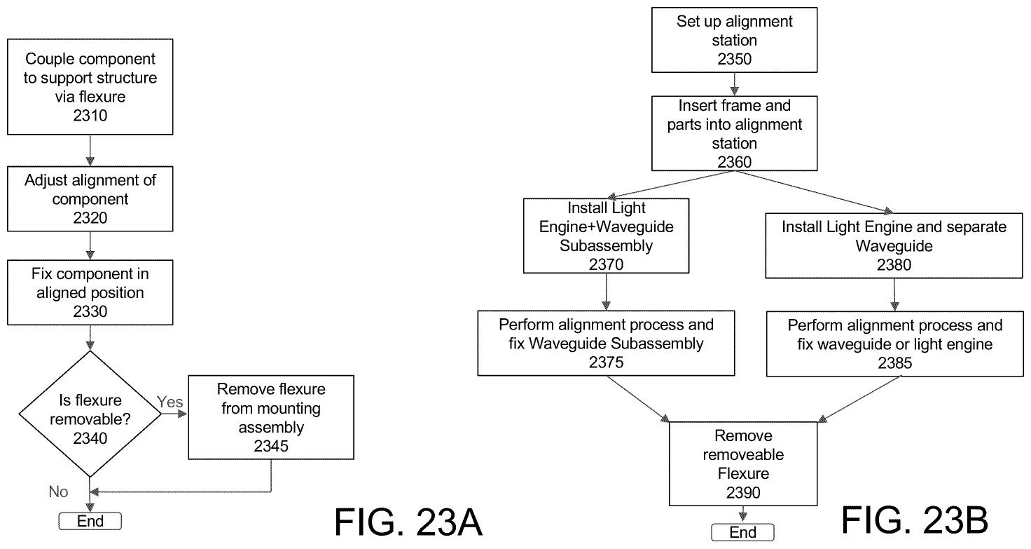

FIG. 23A is a flowchart of one embodiment of attaching and adjusting a component using a flexure. The process starts when the component is coupled to the support structure via a flexure, at block 2310. The alignment of the component is then adjusted at block 2320. This may be done using an alignment station, which uses manipulators to interact with the component and/or the flexure. At block 2330, the component is fixed to the support structure in the aligned position. The support structure may be a frame, a waveguide, or another part. At block 2340, the process determines whether the flexure is removable. If so, at block 2345, the removeable flexure is removed. The tab or other adjustment element may also be removed. The process then ends.

FIG. 23B is a flowchart of one embodiment of using the alignment station with a removable flexure. The process starts when the alignment station is set up, at block 2350. The frame and other parts are inserted into the alignment station, at block 2360. The flexure may be part of the frame and other parts or may be installed into the frame after the frame is in the alignment station. Then, depending on the configuration of the system, either the light engine and waveguide sub assembly is installed, at block 2370, or the light engine and separate waveguide are assembled, at block 2380. In some embodiments, the subassembly/waveguide/light engine may be part of the frame and parts that are pre-assembled, and this step may be skipped.

If the light engine and waveguide sub-assembly is used, the combined subassembly is installed, at block 2370. The alignment process aligns the subassembly at block 2375 and uses a fastener to fix it in place. At block 2390, the removable flexure is removed.

If the light engine and waveguide are separate, the separate components are installed, at block 2380, and aligned at block 2385. The components are then fastened, and at block 2390, the removable flexure is removed.

In some embodiments, the alignment process described with respect to FIGS. 23A and 23B may take place at various partner sites, and may be performed in a different order, such that for example the preliminary assembly of components take place elsewhere than the alignment. For example, the manufacturer may perform a pre-assembly of glasses, including the unaligned light engine. The pre-assembled system, with the component still unaligned can be shipped to a wholesaler, and subsequently to a laboratory. The laboratory can receive an order for a wearable, create the lens with a prescription, laminate the lens to the waveguide, and run the alignment process. Once the alignment is complete, and the light engine is fastened into place, a final optical quality checks are performed. The wearable can then be fitted for the user.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

We claim:

1. A light engine alignment system for a head-mounted device comprising:
a light engine;
a flexure coupled to the light engine, the flexure used to position the light engine at a particular alignment to set a projection axis; and
a fastener to affix the light engine to the head-mounted device at the particular alignment set by the flexure.

2. The system of claim 1, further comprising:
a frame;
wherein the light engine is coupled to the frame.

3. The system of claim 1, further comprising:
a waveguide to display an image from the light engine, the particular alignment of the light engine set with respect to an in-coupler of the waveguide.

4. The system of claim 1, further comprising:
a second flexure to enable adjustment of a second light engine for binocular vision.

5. The system of claim 1, wherein the flexure comprises one or more flexible zones that permit a movement of up to 10 degrees for six degrees of freedom.

6. The system of claim 5, where the flexible zones comprise one or more tabs that interface with the light engine.

7. The system of claim 1, where the flexure is made of one or more of: sheet metal, wire, smart material, or polymer.

8. The system of claim 1, wherein the fastener comprises one or more of: a mechanical adhesive and a chemical adhesive.

9. The system of claim 1, further comprising:
an adjustment element on the light engine, the adjustment element used to move the light engine for positioning.

10. The system of claim 9, wherein the adjustment element comprises a tab, the tab designed to be removed after the fastener affixes the light engine to the head-mounted device.

11. The system of claim 1, wherein the fastener comprises zero hold power actuators.

12. The system of claim 1, wherein the flexure is integrated into a housing of the light engine.

13. The system of claim 1, wherein the flexure is a temporary component and is removed after the fastener affixes the light engine in the particular alignment.

14. The system of claim 1, where the fastener affixes the light engine to one of: a waveguide, a frame, or a fixed non-adjustable portion of the head-mounted device.

15. The system of claim 1, further comprising:
an alignment station comprising:
a holder to hold the head-mounted device including the light engine;
a manipulator to adjust an orientation of the light engine to the particular alignment.

16. An alignment system for aligning a pair of components:
a first component for alignment and a second component for alignment;
a first flexure coupled to the first component, the first flexure used to adjust a position of the first component to a first particular alignment;
a second flexure coupled to the second component, the second flexure used to adjust a position of the second component to a second particular alignment, such that the first particular alignment and the second particular alignment are matched; and
a fastener to affix the first component and the second component to a rigid support structure at the particular alignments set by the flexure.

17. The system of claim 16, wherein the flexure comprises a frame element with one or more flexible zones that permit a movement of up to 10 degrees in three axes of rotation.

18. The system of claim 17, where the flexure is made of one of: metal, shape memory alloy, and polymer.

19. The system of claim 16, wherein the fastener comprises one of: a chemical fastener or a mechanical fastener.

20. The system of claim 16, wherein the fastener comprises zero hold power actuators.

21. The system of claim 16, wherein the component for alignment comprises one of: a light engine, a light engine coupled to a waveguide, a waveguide, a light engine coupled to a light engine mount.

22. The system of claim 16, wherein the flexure is removable, after the fastener is used to affix the component.

23. The system of claim 16, where the rigid support structure comprises one of: a waveguide, a frame, and another fixed non-adjustable portion of a head-mounted device.

24. The system of claim 16, wherein the component comprises one of: a steering prism, a turning prism, a camera, an eye tracking sensor, or another optical element.

25. A light engine alignment system for a wearable device comprising:
a light engine;
a flexure to couple the light engine to a waveguide, the flexure used to position the light engine to set a projection axis; and
a fastener to affix the light engine to a rigid component of the wearable device, at the position.
